(19) United States
(12) Patent Application Publication
(10) Pub. No.: US 2025/0334870 A1
(43) Pub. Date: Oct. 30, 2025

(54) OPTICAL DEVICE, OPTICAL MODULE AND IMAGING DEVICE

(71) Applicant: TDK CORPORATION, Tokyo (JP)

(72) Inventors: Shuntaro Kodama, Hong Kong (HK); Hiroshi Take, Hong Kong (HK); Kenji Nagase, Hong Kong (HK); Cheng Bu Heng, Hong Kong (HK); Anthony Reymund Melad Binarao, Hong Kong (HK)

(73) Assignee: TDK CORPORATION, Tokyo (JP)

(21) Appl. No.: 19/079,783

(22) Filed: Mar. 14, 2025

(30) Foreign Application Priority Data
Mar. 21, 2024 (JP) 2024-044968

(51) Int. Cl. G03B 21/20

(52) U.S. Cl. CPC G03B 21/208; G03B 21/2013; G03B 21/2033

(57) ABSTRACT

An optical device includes: a waveguide module; and a light-emitting module, in which the waveguide module includes: a base layer; a cover layer; and a waveguide layer disposed between the base layer and the cover layer, and including an optical waveguide having an incident end facet that has a curved surface and on which a laser beam to be propagated becomes incident, and the light-emitting module includes: a laser diode that emits the laser beam; and a carrier that supports the laser diode in such a manner that an emergent surface from which the laser beam emerges is positioned facing and spaced apart from the incident end facet, and that is integrated with the waveguide module by being bonded to the base layer.

### CROSS REFERENCE TO RELATED APPLICATION

This application claims the benefit of Japanese Priority Patent Application No. 2024-044968 filed on Mar. 21, 2024, the entire contents of which are incorporated herein by reference.

### FIELD

The present disclosure relates to an optical device, an optical module, and an image forming apparatus.

### BACKGROUND

To put an optical device including an optical waveguide into use, the optical device is connected to a laser diode serving as a light source, to an optical fiber through which communication signals are propagated, or to another optical device, for example. To connect the end facets of two optical waveguides, an organic adhesive is used (see Patent Publication JP-A-H5-142441, for example).

### SUMMARY

Light advancing through a material become partially reflected upon encountering a different material. Therefore, when an organic adhesive is used in the connection between the end facets of optical waveguides, a large amount of back-reflected light is generated at the interface. It has been found that generation of such back-reflected light causes instability, such as fluctuations in wavelength, in a configuration in which a laser diode is used as a light source and the light output from the laser diode is guided to an optical waveguide.

An optical device according to a first aspect of the present disclosure includes: a waveguide module; and a light-emitting module, in which the waveguide module includes: a base layer; a cover layer; and a waveguide layer disposed between the base layer and the cover layer, and including an optical waveguide having an incident end facet that has a curved surface and on which a laser beam to be propagated becomes incident, and the light-emitting module includes: a laser diode that emits the laser beam; and a carrier that supports the laser diode in such a manner that an emergent surface from which the laser beam emerges is positioned facing and spaced apart from the incident end facet, and that is bonded to the base layer so as to be integrated with the waveguide module.

Furthermore, an image forming apparatus according to a second aspect of the present disclosure uses the optical device further including: a substrate having a first side surface; and
a waveguide layer stacked on the substrate, and having a second side surface that is continuous with the first side surface and that has an incident end facet through which light becomes incident on a waveguide on the second side surface; wherein
the incident end facet has a curved surface.

The present disclosure can provide an optical device and the like enabling light emitted from a laser diode to stably become incident on an optical waveguide.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a schematic diagram illustrating a configuration of a projector using an optical device according to one example embodiment;

FIGS. 2A and 2B are a plan view and a front view, respectively, of the optical device;

FIG. 3 is a cross-sectional view taken along X-X as a first embodiment;

FIG. 4 is a cross-sectional view taken along X-X as a second embodiment; and

FIG. 5 is a partial perspective view of a waveguide module according to a third embodiment.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

Embodiments of the present disclosure will now be described with reference to the accompanying drawings. In each of the drawings, elements assigned with the same reference numerals have the same or similar configuration. The embodiments are, however, not intended to limit the scope of the technology as defined in the appended claims. Furthermore, all of the configurations described in the embodiments are not necessarily essential as means for solving the problem.

The present disclosure has been made to solve such a problem, and provides an optical device and the like enabling light emitted from a laser diode to stably become incident on an optical waveguide.

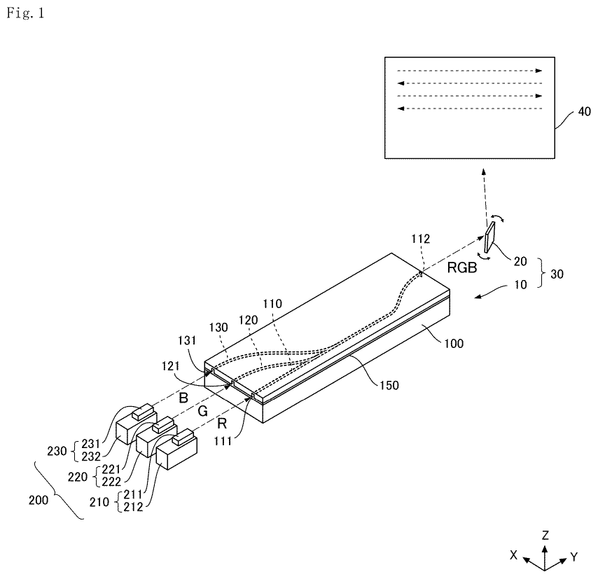

FIG. 1 is a schematic diagram illustrating a configuration of a projector 30 using an optical device 10 according to one example embodiment. The projector 30 casts a projection of a video on the screen 40 by causing micro electro mechanical systems (MEMS) mirrors to reflect the projection light output from the optical device 10 in different directions over the time, and to scan across the screen 40.

The optical device 10 includes a waveguide module 100 and a light-emitting module 200. In this embodiment, the light-emitting module 200 includes three modules that are a red light-emitting module 210, a green light-emitting module 220, and a blue light-emitting module 230. These modules are bonded to and integrated with the end facet of the waveguide module 100, as will be described later; however, in the drawing, these modules are illustrated in a manner spaced apart from the end facet of the waveguide module 100.

The waveguide module 100 may have a cuboid shape as a whole. In the drawings, a short-hand direction, among the plane directions, is defined as an X-axis direction, and a longitudinal direction is defined as a Y-axis direction. The height direction orthogonal to the plane directions is defined as a Z-axis direction. The same coordinate axes, which use the orientation of the waveguide module 100 illustrated in FIG. 1 as a reference, are also included in the subsequent drawings, to indicate the orientations of structures represented in each of the drawings.

The waveguide module 100 includes a waveguide layer 150 that is in parallel with the XY plane. The waveguide layer 150 is formed of an electro-optical material, such as a lithium niobate film. By partially removing the waveguide layer 150 by etching, for example, a ridge having a projecting shape in a cross section is left out unremoved. This ridge serves as an optical waveguide along which a laser beam is propagated. In this embodiment, three optical waveguides, a first optical waveguide 110, a second optical waveguide 120, and a third optical waveguide 130, are formed as a part of the waveguide layer.

The first optical waveguide 110 may delineate a straight line or gently curved line that is continuous from a first incident end facet 111 to an emergent end facet 112. The first incident end facet 111 is exposed on one side surface of the waveguide module 100, and the emergent end facet 112 is exposed on the opposite side surface of the waveguide module 100. In other words, the laser beam becoming incident on the first incident end facet 111 propagates through the first optical waveguide 110, and emerges out of the emergent end facet 112.

The second optical waveguide 120 may delineate a straight line or gently curved line that is continuous from a second incident end facet 121 to an intermediate point where the second optical waveguide 120 merges the first optical waveguide 110. The second incident end facet 121 is exposed on the one side surface of the waveguide module 100, the one surface being the surface having the first incident end facet 111. In other words, the laser beam becoming incident on the second incident end facet 121 propagates through the second optical waveguide 120, merges the first optical waveguide 110 on the way to the emergent end facet 112, and emerges out of the emergent end facet 112.

The third optical waveguide 130 may delineate a straight line or gently curved line that is continuous from a third incident end facet 131 to an intermediate point where the third optical waveguide 130 merges the first optical waveguide 110. The third incident end facet 131 is exposed on the one side surface of the waveguide module 100, the one surface being the surface having the first incident end facet 111. In other words, the laser beam becoming incident on the third incident end facet 131 propagates through the third optical waveguide 130, merges the first optical waveguide 110 on the way to the end facet 112, and emerges out of the emergent end facet 112.

Note that the configurations of these three optical waveguides are not limited to the example described above, and may be any configurations as long as each of the optical waveguides has an incident end facet, and merges the others on the way to a common emergent end facet. The optical waveguide may also have two or more emergent end facets by branching again on the downstream side of the merging point of the three optical waveguides.

The red light-emitting module 210 includes a red laser diode 211 and a first carrier 212 supporting the red laser diode 211. The red laser diode 211 is fixed at a predetermined position on the first carrier 212, as will be specifically described below. The red laser beam output from the red laser diode 211 becomes incident on the first incident end facet 111 of the first optical waveguide 110.

The green light-emitting module 220 includes a green laser diode 221 and a second carrier 222 supporting the green laser diode 221. The green laser diode 221 is fixed at a predetermined position on the second carrier 222, as will be specifically described below. The green laser beam output from the green laser diode 221 becomes incident on the second incident end facet 121 of the second optical waveguide 120.

The blue light-emitting module 230 includes a blue laser diode 231 and a third carrier 232 supporting the blue laser diode 231. The blue laser diode 231 is fixed at a predetermined position on the third carrier 232, as will be specifically described below. The blue laser beam output from the blue laser diode 231 becomes incident on the third incident end facet 131 of the third optical waveguide 130. Note that the positional relationships of the light-emitting modules corresponding to the respective colors with respect to the optical waveguides are not limited to the configuration described above. For example, the red light-emitting module 210 may be positioned correspondingly to the third optical waveguide 130, and the blue light-emitting module 230 may be positioned correspondingly to the first optical waveguide 110.

As described above, because the second optical waveguide 120 and the third optical waveguide 130 merge the first optical waveguide 110, when the light beams are output from a plurality of laser diodes simultaneously, mixed light resulting from these light beams is output from the emergent end facet 112. More specifically, by causing the red laser diode 211, the green laser diode 221, and the blue laser diode 231 to emit light beams having the respective light intensities controlled, it is possible to output light of any intended color from the emergent end facet 112.

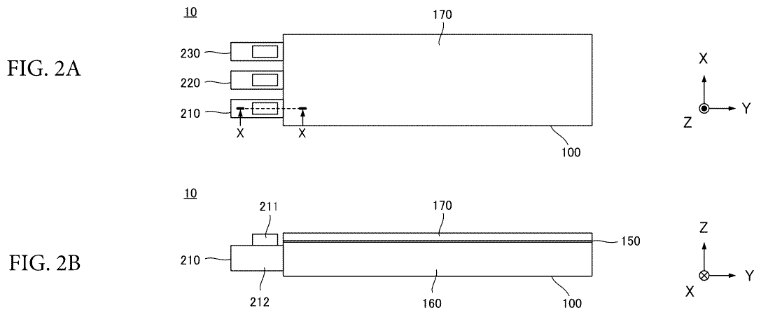

FIG. 2A is a plan view, and FIG. 2B is a front view of the optical device 10. As illustrated in the front view, the waveguide module 100 includes a substrate 160 as a base layer, the waveguide layer 150 stacked on the substrate 160, and a buffer layer 170 as a cover layer covering the waveguide layer. As the substrate 160, for example, an Si substrate or a sapphire substrate is used. The buffer layer 170 is formed of a highly transparent material having a lower refractive index than that of the waveguide layer 150, and alumina (Al₂O₃) is used, for example. In this embodiment, the space removed from the waveguide layer 150 by etching or the like, for the purpose of forming the optical waveguides, is filled by the buffer layer 170; however, this space may also provide a protective layer formed of silicon dioxide (SiO₂), for example. Furthermore, in this embodiment, the substrate 160 is used as the base layer and the buffer layer 170 is used as the cover layer, but at least one of the substrate 160 or the buffer layer 170 may be replaced with a cladding layer, or provided as a cladding layer. The cladding layer is formed of a material having a lower refractive index than that of the waveguide layer 150, and yttrium oxide (Y₂O₃) is used, as an example.

A first side surface 161 of the substrate 160 and a second side surface 151 of the waveguide layer 150 may be continuous, and the second side surface 151 may include the incident end facet 111 through which the light becomes incident on the waveguide. The incident end facet 111 has a curved surface, and the curved surface may be a curved surface continuous with at least a part of the first side surface. The second side surface 151 of the waveguide layer 150 and a third side surface 171 of the buffer layer 170 may also be continuous, and the curved surface of the second side surface 151 may be a curved surface continuous with at least a part of the third side surface 171.

In each of the light-emitting modules (the red light-emitting module 210, the green light-emitting module 220, and the blue light-emitting module 230), the carrier corresponding thereto (the first carrier 212, the second carrier 222, and the third carrier 232) is bonded to the substrate 160 and integrated with the waveguide module 100. The one side surface of the waveguide module 100, where the light-emitting modules are bonded, may be applied with an anti-reflection film and an SAC coating, and the opposite side surface including the emergent end facet 112 may be applied with an anti-reflection film. A bonded surface of each of the carriers, the bonded surface being bonded to the substrate 160, may be applied with Au coating.

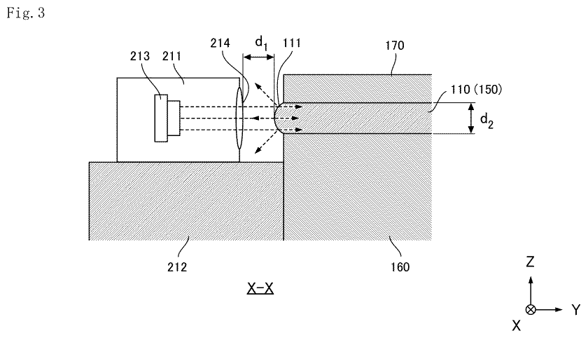

Among the embodiments, FIG. 3 is a cross-sectional view taken along X-X as a first embodiment. In the first embodiment, each of the incident end facets (in FIG. 3, the first incident end facet 111 is illustrated) has a curved surface bulging toward the corresponding laser diode (in FIG. 3, the red laser diode 211 is illustrated).

Illustrated in FIG. 3 is a simplified cross-section of the red laser diode 211. The red laser diode 211 includes a light emitter 213, and the red laser beam output from the light emitter 213 emerges out of an emergent surface 214 of the red laser diode 211, advances through the air (or a transmission medium), and becomes incident on the first incident end facet 111, into the first optical waveguide 110. When the red laser beam becomes incident on the first incident end facet 111, part of the red laser beam is reflected by the first incident end facet 111, but because the first incident end facet 111 has a curved surface bulging toward the red laser diode 211, the back-reflected light directly returning to the light emitter 213 is significantly reduced, compared with that in a configuration in which the first incident end facet 111 is flat, and most of the reflected light scatters in directions other than that toward the light emitter 213, in the space between the emergent surface 214 and the first incident end facet 111.

If the first incident end facet 111 is flat and a large portion of the reflected light reaches the light emitter 213 as back-reflected light, the wavelength or the intensity of the red laser beam emitted from the light emitter 213 fluctuates, and such fluctuations obstructs stable light emission. However, in this embodiment, because the first incident end facet 111 has a curved surface, and the emergent surface 214 of the red laser diode 211 and the first incident end facet 111 of the first optical waveguide 110 are disposed facing and spaced apart from each other, a large portion of the reflected light scatters in directions toward the periphery of the emergent surface 214, without returning as the back-reflected light. Therefore, the light emitter 213 is allowed to emit a red laser beam stably.

At this time, the shortest distance d₁ between the emergent surface 214 of the red laser diode 211 and the first incident end facet 111 of the first optical waveguide 110 may be equal to or greater than a thickness d₂ of the first optical waveguide 110. By ensuring such a space, a large portion of the reflected light is allowed to scatter toward the periphery of the emergent surface 214. In other words, the curved surface of the first incident end facet 111 may be processed in such a manner that, given such a shortest distance, a large portion of reflected light scatters toward the periphery. Specifically, the curved surface of the first incident end facet 111 may be designed in such a manner that 10% or more of the reflected light scatters toward the periphery, more preferably, 50% or more scatters toward the periphery. The curved surface of the first incident end facet 111 may be, for example, a spherical surface or a cylindrical surface. When the curved surface is a cylindrical surface, the cylindrical surface may have a central axis in parallel with the X-axis, as illustrated in FIG. 3, or have a central axis in parallel with the Z-axis. In a configuration in which the cylindrical surface has a central axis parallel with the Z-axis, the cylindrical surface may be provided correspondingly to each of the incident end facets.

The second incident end facet 121 and the green light-emitting module 220 corresponding thereto, and the third incident end facet 131 and the blue light-emitting module 230 corresponding thereto have the same configurations as those of the first incident end facet 111 and the red light-emitting module 210 corresponding thereto. Therefore, all of these modules can suppress back-reflected light and emit the laser beam stably. In particular, in applications in which light having an intended color is output by mixing laser beams with different colors in the optical waveguide, as in this embodiment, it is particularly important to stabilize each of the laser beams because the color fluctuates when any of the laser beams becomes unstable.

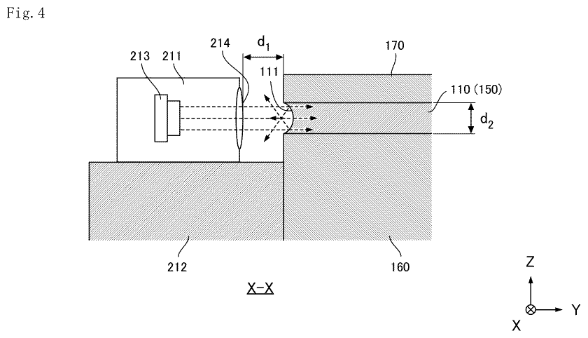

Among the embodiments, FIG. 4 is a cross-sectional view taken along X-X as a second embodiment. In the second embodiment, each of the incident end facets (in FIG. 4, the first incident end facet 111 is illustrated) has a curved surface recessing toward the opposite side of the corresponding laser diode (in FIG. 4, the red laser diode 211 is illustrated).

With a configuration in which the first incident end facet 111 has such a curved surface and in which the emergent surface 214 of the red laser diode 211 and the first incident end facet 111 of the first optical waveguide 110 are disposed facing and spaced apart from each other, too, a large portion of the reflected light is allowed to scatter toward the periphery of the emergent surface 214. Therefore, the light emitter 213 is allowed to emit a red laser beam stably.

In the configuration having such a curved surface, the shortest distance d₁ between the emergent surface 214 of the red laser diode 211 and the first incident end facet 111 of the first optical waveguide 110 may be equal to or greater than a thickness d₂ of the first optical waveguide 110. By ensuring such a space, a large portion of the reflected light is allowed to scatter toward the periphery of the emergent surface 214. In other words, the curved surface of the first incident end facet 111 may be processed in such a manner that, given such a shortest distance, a large portion of reflected light scatters toward the periphery. Specifically, the curved surface of the first incident end facet 111 may be designed in such a manner that 50% or more of the reflected light scatters toward the periphery. The curved surface of the first incident end facet 111 may be, for example, a spherical surface or a cylindrical surface. The second incident end facet 121 and the green light-emitting module 220 corresponding thereto, and the third incident end facet 131 and the blue light-emitting module 230 corresponding thereto have the same configurations as those of the first incident end facet 111 and the red light-emitting module 210 corresponding thereto.

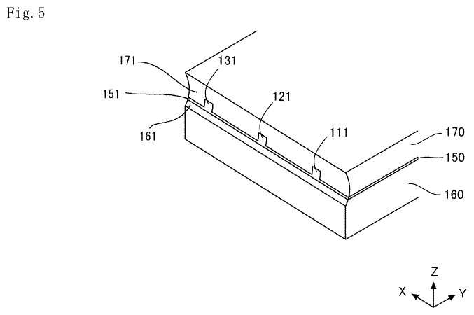

Among the embodiments, FIG. 5 is a partial perspective view of the waveguide module 100 as a third embodiment. The third embodiment shares the same feature with the second embodiment in that each of the incident end facets (the first incident end facet 111, the second incident end facet 121, and the third incident end facet 131) has a curved surface recessing toward the opposite side of the corresponding laser diode, but is an example in which each of the three incident end facets is particularly processed to the same curved surface as those of the others.

Specifically, as illustrated, a part of the end facet of the substrate 160 and the end facet of the buffer layer 170 are processed to a cylindrical curved surface that is continuous with the curved surfaces of the respective incident end facets. In other words, the curved surfaces of the respective incident end facets are formed, for example, by grinding these layers simultaneously. With such a machining method, the curved surface can be formed easily in a short time period. Furthermore, when each of the three incident end facets has the identical curved surface, all of the laser diodes are affected by the back-reflected light by substantially the same degree, so that the color mixture can be maintained without significantly going out of the balance. In the example illustrated in FIG. 5, a concave curved surface is used, but the surface may be processed into a convex curved surface.

Although explained above in the embodiments is an example in which the optical device 10 outputs light in an intended color by allowing the laser beams of primary R, G, and B colors to become mixed in the optical waveguide, applications of the optical device are not limited to such a what is called RGB coupler. When the optical device is to be used in any other application, the optical device may include one light-emitting module, and have a single-path optical waveguide. In the same manner, in the configuration in which a plurality of light-emitting modules are bonded, the number of light-emitting modules to be bonded may be two, or four or more, without limitation to the three. In such a case, the incident end facets as well as the optical waveguides may be provided correspondingly to the number of light-emitting modules, and a plurality of the optical waveguides may merge together as one, or have emergent end facets that are independent from one another.

1. An optical device comprising:
a waveguide module; and
a light-emitting module, wherein
the waveguide module includes:
a base layer;
a cover layer; and
a waveguide layer disposed between the base layer and the cover layer, and including an optical waveguide having an incident end facet that has a curved surface and on which a laser beam to be propagated becomes incident, and
the light-emitting module includes:
a laser diode that emits the laser beam; and
a carrier that supports the laser diode in such a manner that an emergent surface from which the laser beam emerges is positioned facing and spaced apart from the incident end facet, and that is integrated with the waveguide module by being bonded to the base layer.

2. The optical device according to claim 1, wherein at least a part of an end facet of each of the base layer and the cover layer has a curved surface that is continuous with the curved surface of the incident end facet.

3. The optical device according to claim 1, wherein the shortest distance between the emergent surface and the incident end facet is equal to or greater than a thickness of the optical waveguide.

4. The optical device according to claim 1, wherein
the waveguide layer has a plurality of the incident end facets,
the optical waveguides continuous with the plurality of respective incident end facets merge inside of the waveguide module, and are connected to an emergent end facet, and
the light-emitting module includes a plurality of the laser diodes corresponding to the plurality of respective incident end facets.

5. The optical device according to claim 1, wherein
the waveguide layer has three incident end facets, and the optical waveguides continuous with the respective three incident end facets merge inside of the waveguide module, and are connected to an emergent end facet, and
the light-emitting module includes three laser diodes corresponding to the respective three incident end facets, and configured to emit red, green, and blue light, respectively.

6. The optical device according to claim 5, wherein each of the three incident end facets is machined to have a curved surface identical to curved surfaces of the other respective incident end facets.

7. A waveguide module comprising:
a substrate having a first side surface;
and
a waveguide layer stacked on the substrate, and having a second side surface that is continuous with the first side surface and that has an incident end facet through which light becomes incident on a waveguide on the second side surface;
wherein
the incident end facet has a curved surface.

8. The waveguide module according to claim 7, wherein the curved surface has a curved surface that is continuous with at least a part of the first side surface.

9. The waveguide module according to claim 7, further comprising a buffer layer that is stacked on the waveguide layer, made of a material having a lower refractive index than a refractive index of the waveguide, and has a third side surface continuous with the second side surface, wherein
the curved surface has a curved surface continuous with at least a part of the third side surface.
